(19) United States
(12) Patent Application Publication
(10) Pub. No.: US 2016/0137367 A1
(43) Pub. Date: May 19, 2016

(54) VIAL FOR FLUID PRODUCTS, PARTICULARLY FOR MEDICAL, PHARMACEUTICAL, COSMETIC, FOOD PRODUCTS OR THE LIKE

(71) Applicant: LAMEPLAST S.P.A., Rovereto sul Secchia - Novi di Modena (M (IT)

(72) Inventor: Antonio FONTANA, Carpi (MO) (IT)

(73) Assignee: Lameplast S.P.A., Rovereto sul Secchia (IT)

(21) Appl. No.: 14/904,097

(22) PCT Filed: Aug. 5, 2014
(86) PCT No.: PCT/IB2014/063698

§ 371 Date: Jan. 10, 2016

(30) Foreign Application Priority Data
Sep. 2, 2013 (IT) MO2013A000243

(51) Int. Cl. B65D 55/16; A61J 1/06; B65D 1/02; B65D 1/09

(52) U.S. Cl. CPC B65D 55/165; B65D 1/095; A61J 1/06; B65D 1/0238; A61J 1/067

(57) ABSTRACT

The vial (1) for fluid products, particularly for medicinal, pharmaceutical cosmetic, food products or the like, comprises:
a hollow body (2) for the containment of a fluid product;
a closing cap (5) which, in an initial configuration, is associated integral with the hollow body (2) along a pre-established breaking line (6) able to allow the separation of the closing cap (5) from the hollow body (2) in an opening configuration wherein on the hollow body (2) is obtained an outflow opening (7) of the fluid product in correspondence to the pre-established breaking line (6), the closing cap (5) comprising a substantially sheet-shaped portion (10) for supporting information, data or logos (20); and
at least a steady connection brace (13), which has an extremity associated with the hollow body (2) and an opposite extremity associated with the closing cap (5) and which, in the opening configuration, is deformable without breakage and able to avoid the reciprocal moving away between the closing cap (5) and the hollow body (2) beyond a pre-established distance.

### TECHNICAL FIELD

The present invention relates to a vial for fluid products, particularly adapted to contain products used in the medical, pharmaceutical, cosmetic, food sector or the like.

### BACKGROUND ART

With particular reference to pharmaceutical and/or cosmetic industry the use is known of vials made of polymer material for the packaging of one or more doses of fluid, liquid or pasty products.

The known vials may be of the resealable or disposable type and generally comprise a containment body for containing a predetermined dose of product, with a substantially tubular and elongated shape, which has an extremity provided with a neck, on top of which is defined a dispensing mouth for the product.

The opposite extremity of the containment body has an opening adapted to the introduction of the product, which is closed after filling, e.g., by sealing. Closing means, which are associable in a removable manner with the vials in correspondence to their neck, allow to clog the dispensing mouth.

The containment body and the closing means can be made separately, using forming techniques such as injection molding, and subsequently assembled together, or, alternatively, they can be made in a single body piece and subsequently separated by a user before use.

The containment body also has a pair of fins which are adapted to facilitate the grip of the vial by a user, and which extend, diametrically opposite one another, from the outer lateral surface of the containment body itself.

The known vials can be produced in single units or can be associated with one another in series to form a so-called “strip”; in the latter case, the fins of the containment bodies of two successive vials are temporarily associated with one another in correspondence to easily tearable connection lines with weakened section, allowing the separation of one vial from the other.

With particular reference to the closing means and their conformation, different types of vial are known according to different modes of use and realization.

A first type of known vials provides, e.g., the use of a closing element that, during molding, is made with a portion fixed to the vial neck along predetermined breaking areas, to clog the dispensing mouth.

In other words, the containment body and the closing element are made in a single body piece so that the dispensing mouth of the vial is initially closed and may be opened by tearing off the closing element from the containment body.

Eventually, the closing element may also comprise a cap seat, which is arranged opposite the portion initially fixed to the neck and which has a clogging body suitably sized to be introduced in the dispensing mouth.

In this case the vial is opened for the first time by detaching the closing element from the dispensing mouth in correspondence to the breaking areas and, after using the product, the vial may be reclosed by turning the closing element upside down and by fitting the cap seat on the neck, then positioning the clogging body within the dispensing mouth.

Vials of this type are shown in the patent document EP 0326529 B1.

A second type of resealable vials made in a single body piece comprises closing means having a clogging element, of the cap type or the like, fitted sealed within the dispensing mouth, and deformable or breakable elements that connect, without interruption, the closing means to the vial body.

Such deformable or breakable elements are adapted to signal to the user any possible product contamination due to any tampering and/or accidental opening of the product, thereby acting as a guarantee seal.

Vials of this type are shown in the patent document EP 2139659 B1.

Furthermore, a third type of vials is known, wherein the closing means and the containment body are made in separate pieces, subsequently assembled together. The closing means of such vials generally comprise a handle having a clogging element, of the cap type or the like, which may be fitted sealed within the dispensing mouth, and an annular collar fixable coaxially and interlocking in correspondence to the neck of the containment body.

The handle is associated in a removable manner in correspondence to the outer surface of the collar by means of a suitable weakened area, made up, e.g., of pre-breaking lines, of tearable bridges, of reduced cross-sections or the like.

The handle, the collar and the cap are therefore made in a single body piece, separately from the containment body, and the collar is subsequently fixed to the neck by interlocking, with the cap closing the dispensing mouth.

Vials of this type are shown in the patent document EP 1289842 B 1.

These known vials are however susceptible of further improvements.

In particular, due to European and U.S. standards being increasingly restrictive and stringent, the presence of product-related information is mandatory on each individual vial (instead of on the whole strip and in addition to those commonly indicated on the packaging and/or on additional leaflets).

This need is even greater in the case of strips composed of vials containing different products, wherein the comprehensiveness and clarity of information included in correspondence to each vial is essential.

The information, which may comprise e.g. information on the product dosage, the packaging and/or expiry date, or the like, is generally printed in correspondence to the gripping fins of the vials, by printing or application of labels or the like.

The increasing need to add as much information as possible, in a clearly legible manner, contrasts, on the other hand, to the presence of small surface portions that can be used in correspondence to the gripping fins.

In addition, the remaining portions of the vials are not generally useful for the inclusion of such information, due to the presence of special reliefs, shaping or edging.

To this is added that the law standards of some countries are even more restrictive for particular types of fluid product, such as those intended for oral administration, and require in these cases the information not being printed directly on the containment body of the product, to avoid that the ink may pass through the vial walls and pollute the fluid product, thus reducing even more the available surfaces. To rule out at least in part these drawbacks the patent document WO 2007/107825 A2 and WO2007/107826 A2 teach to make vials having a substantially plate-shaped closing element on which an adhesive label is applied bearing the information required.

In this embodiment, however, the opening of the vial involves the removal of the closing element from the containment body and of the relative label applied on it, thus completely negating its utility.

In some circumstances, however, it is necessary that the information on the vials remains always visible and identifiable by the user even after opening.

### DESCRIPTION OF THE INVENTION

The main aim of the present invention is to provide a vial for fluid products, particularly for medical, pharmaceutical, cosmetic, food products or the like, on which it is possible to include all the product-related information required, in a clear and legible manner.

Another object of the present invention is to provide a vial for fluid products wherein the product-related information is not missed after opening the vial and still remains at the user's disposal.

Another object of the present invention is to provide a vial for fluid products, particularly for medical, pharmaceutical, cosmetic, food products or the like that allows to overcome the mentioned drawbacks of the prior art in the ambit of a simple, rational, easy and effective to use as well as low cost solution.

The above mentioned objects are achieved by the present vial for fluid products, particularly for medical, pharmaceutical, cosmetic, food products or the like, according to claim 1.

### BRIEF DESCRIPTION OF THE DRAWINGS

Other characteristics and advantages of the present invention will become more evident from the description of several preferred, but not exclusive, embodiments of a vial for fluid products, particularly for medical, pharmaceutical, cosmetic, food products or the like, illustrated as an indicative but not limitative example in the accompanying drawings in which:

FIG. 1 is an axonometric view illustrating a strip of vials according to a first embodiment of the invention;

FIGS. 2 to 5 are schematic views illustrating the opening of one of the vials of FIG. 1;

FIG. 6 is an axonometric view illustrating a strip of vials according to a second embodiment of the invention;

FIG. 7 is an axonometric view illustrating a strip of vials according to a third embodiment of the invention;

FIGS. 8 to 13 are schematic views illustrating the opening and reclosing of one of the vials of FIG. 7;

FIG. 14 is an axonometric view illustrating a strip of vials according to a fourth embodiment of the invention;

FIG. 15 is an axonometric view illustrating a strip of vials according to a fifth embodiment of the invention;

FIGS. 16 to 23 are schematic views illustrating the opening and reclosing of one of the vials of FIG. 15;

FIG. 24 is an axonometric view illustrating a strip of vials according to a sixth embodiment of the invention.

### EMBODIMENTS OF THE INVENTION

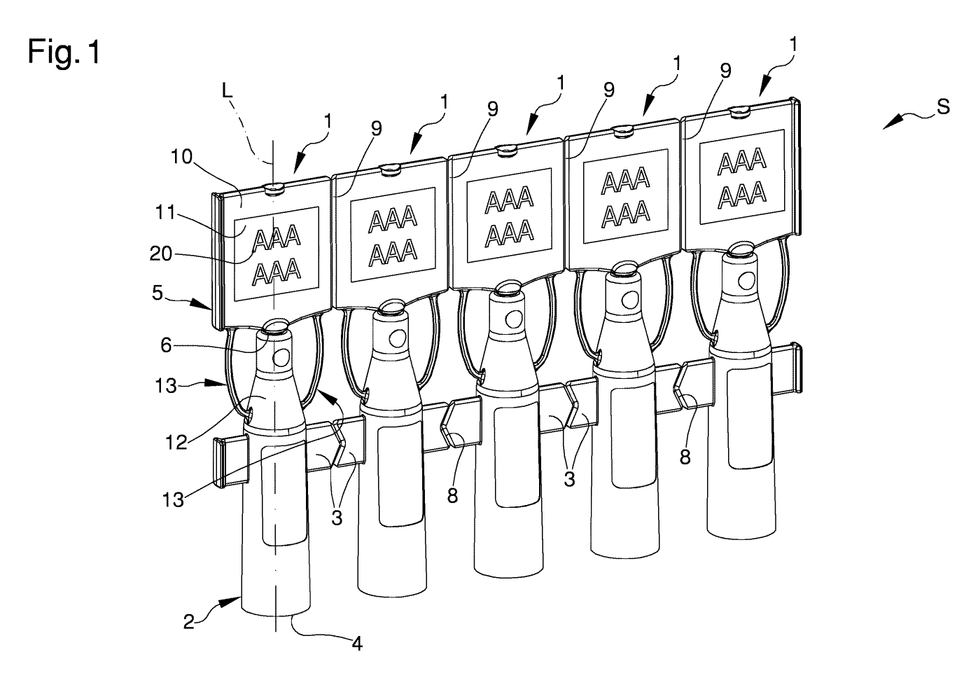

With particular reference to the first embodiment shown in the FIGS. 1 to 5, by reference numeral 1 is indicated a vial for fluid products, particularly for medical, pharmaceutical, cosmetic, food products or the like.

In this respect, it is specified that in the present treatise the term “fluid products” does not only mean liquid products but also viscous products, e.g. in the state of paste and gel, and powder products, particularly very fine powders with great smoothness.

The vial 1 comprises at least a hollow body 2 for the containment of a fluid product. The hollow body 2 has a lateral surface on which is defined a pair of substantially protruding spacing fins 3, which are associated in a removable manner along a first weakened area 8 with the spacing fins 3 of one or more adjacent vials 1, to form a strip S of vials 1 (FIG. 1).

In correspondence to one extremity of the hollow body 2 is defined an introduction mouth 4 of the fluid product; the closing of the mouth 4 (e.g. by sealing of the lips of the opening itself) is made after introducing the fluid product, before entering the vial 1 on the market.

In all the illustrations shown in the accompanying drawings, the mouth 4 and its use to fill the hollow body 2 with the fluid product are never represented in detail; for the sake of simplicity of representation all vials 1 illustrated in the figures are meant as already filled with the fluid product and ready to be opened to allow dispensing.

On the substantially opposite side with respect to the mouth 4, the vial 1 has a closing cap 5.

In an initial configuration, the closing cap 5 is associated integral with the hollow body 2 along a pre-established breaking line 6 able to allow the separation of the closing cap 5 from the hollow body 2 in an opening configuration wherein on the hollow body 2, in correspondence to the pre-established breaking line 6, is obtained an outflow opening 7 through which the fluid product can be dispensed.

The closing cap 5 is associated along second weakened areas 9 with the closing cap 5 of one or more adjacent vials 1, helping to form the strip S.

The closing cap 5 comprises a substantially sheet-shaped portion 10 that supports information, data or logos 20.

The substantially sheet-shaped portion 10 consists, e.g., in a plate of such a thickness to make it quite stiff and non-deformable.

The information 20, which may comprise, e.g., information on the dosage of the product, the packaging and/or expiry date, or the like, is indicated on an adhesive label 11 but alternative embodiments cannot be ruled out wherein it is supported by the plate 10 in a different way.

The hollow body 2 has a longitudinal axis L in correspondence to which are arranged the pre-established breaking line 6 in the initial configuration and the outflow opening 7 in the opening configuration.

The hollow body 2 has an elongated shape, i.e. it extends mainly along the longitudinal axis L; in this respect it is noted that in the present treatise the terms “longitudinal” and “transversal” are used with reference to the direction of greater extension of the hollow body 2.

In the proximity of the closing cap 5, the hollow body 2 ends up into a neck 12 which extends along the longitudinal axis L and has the pre-established breaking line 6 in the initial configuration and the outflow opening 7 in the opening configuration.

The neck 12 has a substantially axial-symmetrical conformation with circular section, with a diameter less than the rest of the hollow body 2.

The shape of the neck 12, in particular, is substantially frusto-conical and ends up into a cylindrical portion with constant section, with coaxial alignment with respect to the hollow body 2; alternative embodiments cannot however be ruled out wherein the walls of the neck 12 have a different shape and, e.g., are not coaxial to the hollow body 2.

The vial 1 also comprises at least a steady connection brace 13, which has one extremity associated with the hollow body 2 and an opposite extremity associated with the closing cap 5.

In the opening configuration the steady connection brace 13 is deformable without breakage and is able to avoid the reciprocal moving away between the closing cap 5 and the hollow body 2 beyond a pre-established distance.

This way, the information, data or logos 20 supported by the substantially sheet-shaped portion 10 remain always available and consultable by the user U even when the 1 vial is opened.

In the embodiment shown in FIGS. 1 to 5, the vial 1 comprises two steady connection braces 13, which are arranged on opposite sides with respect to the longitudinal axis L.

Each steady connection brace 13 has one extremity associated with the neck 12 and the opposite extremity associated with the substantially sheet-shaped portion 10. In the initial configuration the steady connection braces 13 are substantially curvilinear, so as to allow them to bend and straighten out during the opening of the vial 1, as will be better described below.

The hollow body 2, the closing cap 5 and the steady connection braces 13 are made integral in a single body piece in the initial configuration, e.g. by forming techniques such as injection molding, using polymer materials, of the polyethylene or polypropylene type.

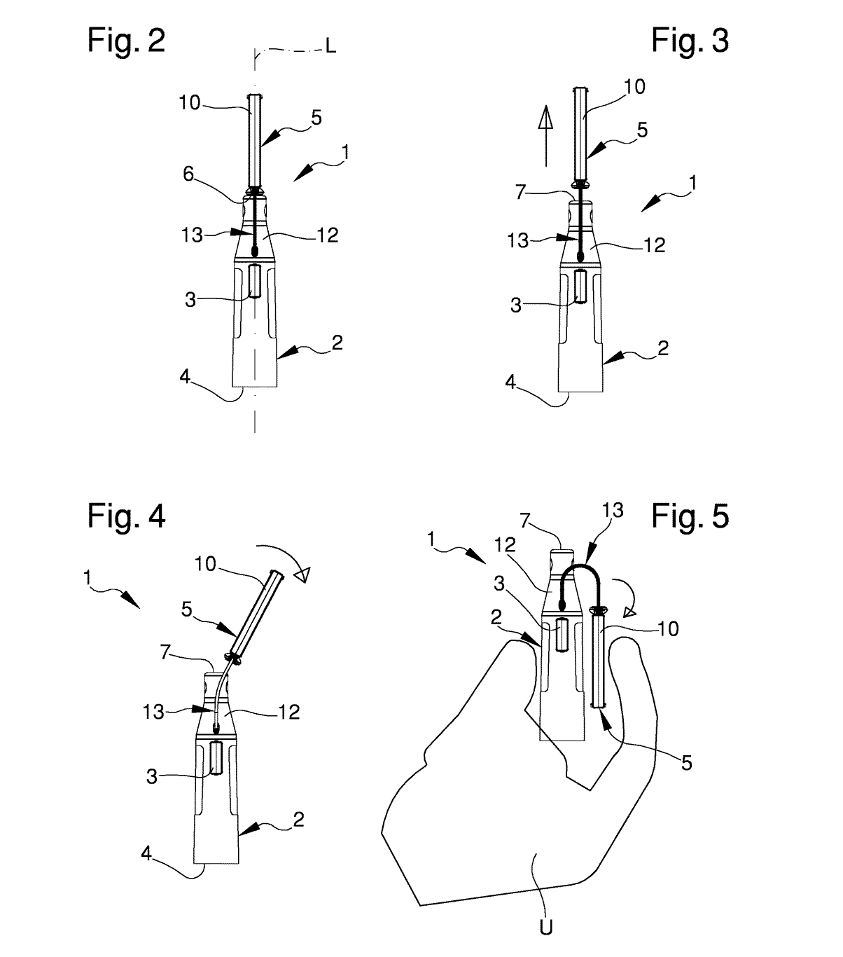

The operation of this first embodiment of the vial 1 is shown in FIGS. 2 to 5.

Starting from the initial configuration (FIG. 2), the user U moves the closing cap 5 away from the hollow body 2 by tearing off the pre-established breaking line 6 (FIG. 3); during this operation the steady connection braces 13 bend and straighten out at least in part thus allowing the reciprocal moving away of the hollow body 2 and the closing cap 5, but never beyond a pre-established distance.

At this point the user U folds the steady connection braces 13 on themselves (FIG. 4) to move the closing cap 5 near the hollow body 2, as shown in FIG. 5, freeing the space facing the outflow opening 7 from any obstacle to enable the dispensing of the fluid product.

In the embodiment shown in FIGS. 1 to 5, the vial 1 is of the “non-resealable” type; once the pre-established breaking line 6, in fact, has been torn off the outflow opening 7 resulting from it can no longer be clogged.

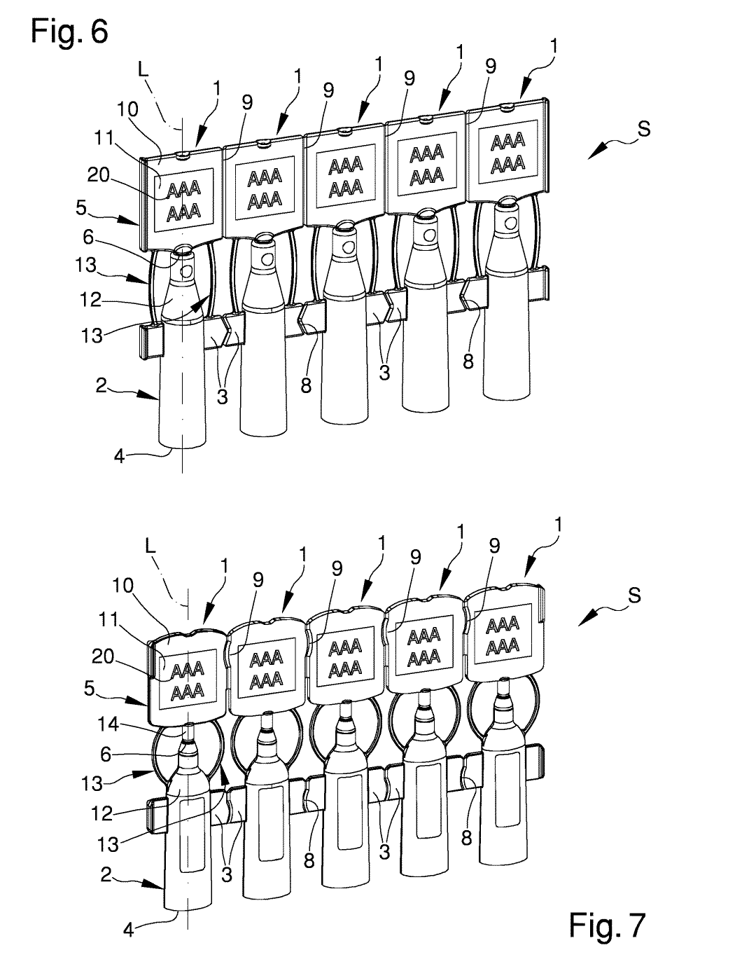

In FIG. 6 is shown a second embodiment of the vials 1 collected in a strip S, wherein each vial 1 comprises a hollow body 2 and a closing cap 5 completely similar to those of the previous embodiment, the detailed description of which is provided integrally.

Even in the embodiment of FIG. 6, the vial 1 comprises two steady connection braces 13 which extend from opposite sides with respect to the longitudinal axis L but which differ from the solution shown in FIGS. 1 to 5 in having one extremity associated with the spacing fins 3 and the opposite extremity associated with the substantially sheet-shaped portion 10.

The operation of the second embodiment of vial 1 does not change compared to that of the previous embodiment, the detailed description of which is provided integrally.

FIG. 7 shows a third embodiment of the vials 1 collected in a strip S.

Beyond some differences in shape compared to the previous embodiments, also in this embodiment the vial 1 comprises a hollow body 2 for the containment of the fluid product, having a longitudinal axis L, a neck 12 and spacing fins 3 connected to the spacing fins 3 of the adjacent vials 1.

Moreover, the vial 1 still comprises a closing cap 5 supporting information, data or logos 20 and connected to the adjacent closing caps 5.

In the initial configuration, the closing cap 5 continues to be integrally associated with the hollow body 2 along a pre-established breaking line 6 adapted to allow the separation of the closing cap 5 from the hollow body 2 in an opening configuration wherein on the hollow body 2, in correspondence to the pre-established breaking line 6, is defined an outflow opening 7 through which the fluid product can be dispensed.

Unlike what happened in the preceding embodiments, the closing cap 5 comprises at least a clogging element 14, the type of a pin or the like, which can be inserted in the outflow opening 7 to reclose the vial 1.

In the initial configuration, the clogging element 14 is associated integral with the hollow body 2 along the pre-established breaking line 6, the clogging element 14 being removable by tearing it off from the hollow body 2 to define the outflow opening 7.

The vial 1 still comprises two steady connection braces 13 which extend between the neck 12 of the hollow body 2 and the closing cap 5 and which are arranged on opposite sides with respect to the longitudinal axis L.

In the initial configuration the steady connection braces 13 still have a substantially curvilinear conformation allowing them to bend and straighten out during the opening of the vial 1.

The hollow body 2, the closing cap 5 and the steady connection braces 13 still are made integral in a single body piece in the initial configuration.

The operation of this third embodiment of vial 1 is shown in FIGS. 8 to 13.

Starting from the initial configuration (FIG. 8), the user U moves the closing cap 5 away from the hollow body 2 by tearing off the pre-established breaking line 6 (FIG. 9); during this operation the steady connection braces 13 bend and straighten out at least in part by allowing the reciprocal moving away of the hollow body 2 and the closing cap 5, but never beyond a pre-established distance.

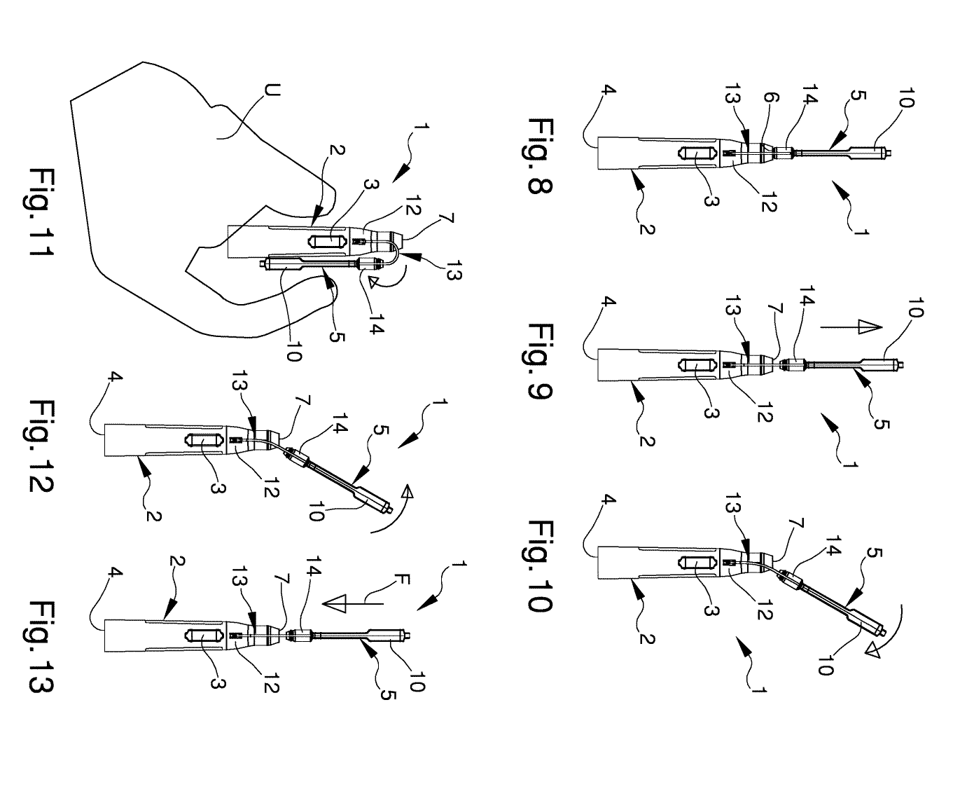

At this point the user U folds the steady connection braces 13 on themselves (FIG. 10) to move the closing cap 5 near the hollow body 2, as shown in FIG. 11, freeing the space facing the outflow opening 7 from any obstacle to enable the dispensing of the fluid product.

In the embodiment shown in FIGS. 7 to 13, the vial 1 is of the “resealable” type; once the pre-established breaking line 6, in fact, has been torn off the outflow opening 7 can be reclosed thanks to the clogging element 14, e.g. to store any unused fluid product remained within the hollow body 2.

For this purpose, the steady connection braces 13 can be folded again on themselves (FIG. 12) to align the clogging element 14 with the outflow opening 7 (FIG. 13), which can be reclosed by pushing the clogging element 14 along a direction F of insertion within the hollow body 2.

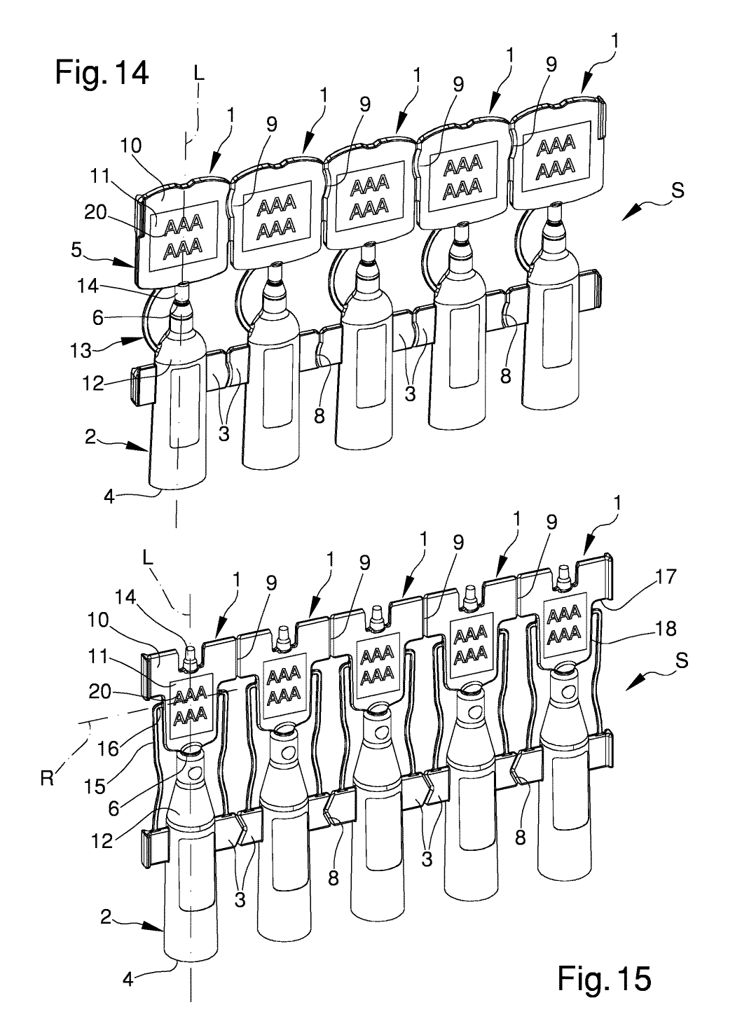

In FIG. 14 is shown a fourth embodiment of vials 1 collected in a strip S, wherein each vial 1 comprises a hollow body 2 and a closing cap 5 completely similar to those of the embodiment illustrated in FIGS. 7 to 13, the detailed description of which is provided integrally.

The embodiment of FIG. 14 differs from the previous one in providing just one steady connection brace 13 instead of two; it is easy to understand, however, that this difference does not in any way change the modes of use of vial 1 which are substantially identical to those shown in FIGS. 8 to 13.

FIG. 15 shows a fifth embodiment of vials 1 collected in a strip S.

Also in this embodiment the vial 1 comprises a hollow body 2, a closing cap 5 and two steady connection braces 13 made integral in a single body piece in the initial configuration.

The hollow body 2 for the containment of the fluid product still has a longitudinal axis L, a neck 12 and spacing fins 3 connected to the spacing fins 3 of the adjacent vials 1.

The closing cap 5 still supports information, data or logos 20 and is connected to the adjacent closing caps 5.

In the initial configuration, the closing cap 5 is still integrally associated with the hollow body 2 along a pre-established breaking line 6 adapted to allow the separation of the closing cap 5 from the hollow body 2 in the opening configuration, wherein on the hollow body 2, in correspondence to the pre-established breaking line 6, is defined the outflow opening 7 through which the fluid product can be dispensed.

Even in this case the closing cap 5 comprises a clogging element 14 which is associated with the substantially sheet-shaped portion 10 and can be inserted in the outflow opening 7 to reclose the vial 1 once this has been opened.

Unlike what happened in the embodiments of FIGS. 7 to 14, in the initial configuration the clogging element 14 is associated with the substantially sheet-shaped portion 10 in a different point with respect to the pre-established breaking line 6 and, in the opening configuration, the steady connection braces 13 can be deformed to allow the alignment of the clogging element 14 with the outflow opening 7.

More in detail, in the initial configuration the clogging element 14 is associated with the substantially sheet-shaped portion 10 on opposite side with respect to the pre-established breaking line 6 and, in other words, lies on the longitudinal axis L but is turned in the opposite direction with respect to the hollow body 2.

Furthermore, in the opening configuration the steady connection braces 13 are deformable so as to allow the rotation of the substantially sheet-shaped portion 10 by about 180° around a rotation axis R to obtain, as mentioned, the alignment of the clogging element 14 with the outflow opening 7.

The rotation axis R is substantially orthogonal to the longitudinal axis L and is defined by the particular shape of the steady connection braces 13.

The steady connection braces 13, in fact, extend between the hollow body 2 and the closing cap 5 on opposite sides with respect to the longitudinal axis L and comprise:
a first length 15 substantially longitudinal, that is, a length which extends mainly in a direction parallel to the longitudinal axis L, but which comprises at least a part having a substantially curvilinear conformation which allows the steady connection braces 13 to bend and straighten out during the opening of the vial 1. The first length 15 of the steady connection braces 13 is associated with the hollow body 2 and, more precisely, with the spacing fins 3; and
a second length 16 substantially transversal, that is, a length which extends mainly in a direction transversal to the longitudinal axis L. The second length 16 of the steady connection braces 13 is connected to the first length 15, is associated with the closing cap 5 and defines the rotation axis R. More specifically, with respect to the previous embodiments, the substantially sheet-shaped portion 10 is shaped so as to have two lateral recesses 17 which define two lateral edges 18 distinct from the second weakened areas 9 in correspondence to which the second lengths 16 of the steady connection braces 13 are attached.

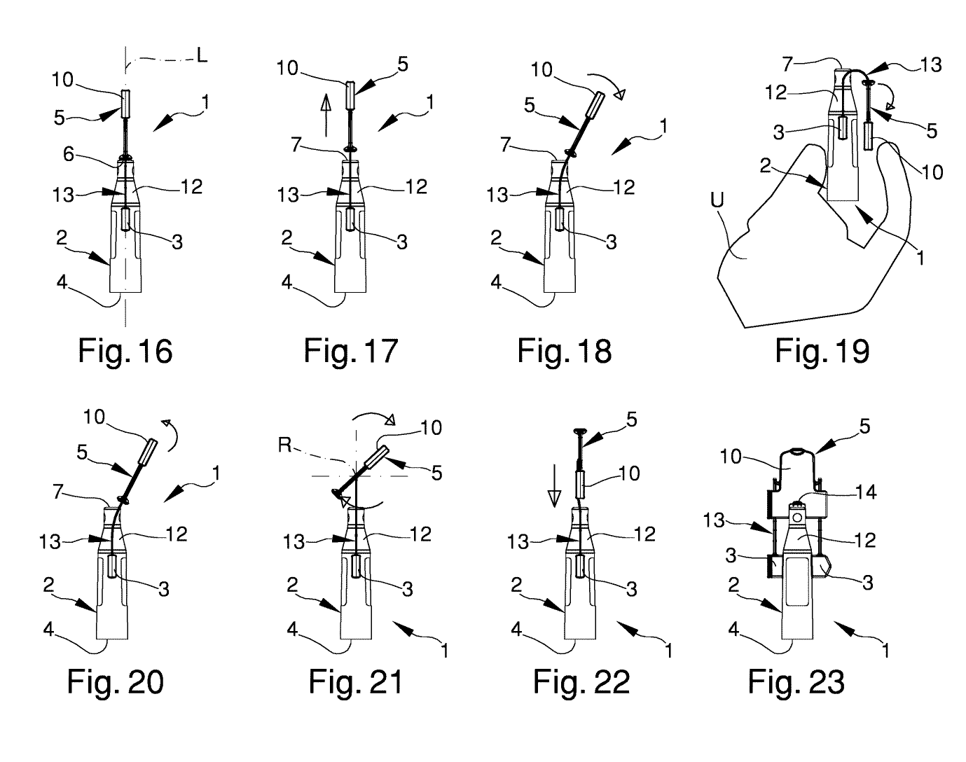

The operation of this fifth embodiment of vial 1 is shown in FIGS. 16 to 23.

Starting from the initial configuration (FIG. 16), the user U moves the closing cap 5 away from the hollow body 2 by tearing off the pre-established breaking line 6 (FIG. 17); during this operation the first lengths 15 of the steady connection braces 13 bend and straighten out at least in part thus allowing the reciprocal moving away of the hollow body 2 from the closing cap 5, but never beyond a pre-established distance.

At this point the user U folds the first lengths 15 of the steady connection braces 13 on themselves (FIG. 18) to move the closing cap 5 near the hollow body 2, as shown in FIG. 19, freeing the space facing the outflow opening 7 from any obstacle to enable the dispensing of the fluid product.

In the embodiment shown in FIGS. 15 to 23, the vial 1 is of the “resealable” type; once the pre-established breaking line 6, in fact, has been torn off the outflow opening 7 can be reclosed thanks to the clogging element 14, e.g. to store any unused fluid product remained within the hollow body 2.

For this purpose, the first lengths 15 of the steady connection braces 13 are folded on themselves (FIG. 20) to straighten them out, the closing cap 5 is rotated around the rotation axis R pivoting on the second lengths 16 of the steady connection braces 13 (FIG. 21) to align the clogging element 14 with the outflow opening 7 (FIG. 22), which can be reclosed by pushing the clogging element 14 along a direction F of insertion within the hollow body 2 (FIG. 23).

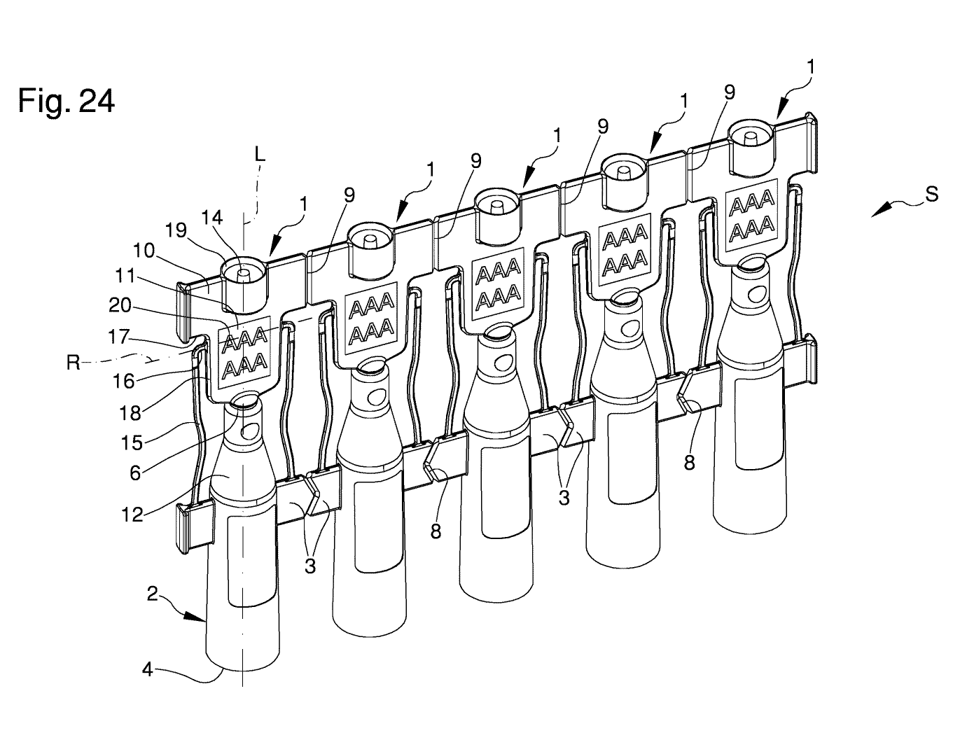

FIG. 24 shows a sixth embodiment of vials 1 collected in a strip S, wherein each vial 1 comprises a hollow body 2, a closing cap 5 and two steady connection braces 13 completely similar to those of the embodiment illustrated in FIGS. 15 to 23, the detailed description of which is provided integrally.

The embodiment of FIG. 24 differs from the previous one in that the closing cap 5 comprises at least a cylindrical wall 19 which is associated with the substantially sheet-shaped portion 10 around the clogging element 14.

Usefully, the cylindrical wall 19 is substantially coaxial to the clogging element 14 and can be fitted around the neck 12 when the clogging element 14 is inserted in the outflow opening 7 to reclose the vial 1.

The cylindrical wall 19 fitted on the neck 12 better stabilizes the closing cap 5 in closing position and improves the tight sealing of the outflow opening 7 by means of the clogging element 14.

It is easy to understand, finally, that the presence of the cylindrical wall 19 does not change in any way the modes of use of vial 1 which are substantially identical to those shown in FIGS. 16 to 23.

1) Vial (1) for fluid products, particularly for medicinal, pharmaceutical cosmetic, food products or the like, comprising:
at least a hollow body (2) for the containment of a fluid product; and
at least a closing cap (5) which, in an initial configuration, is associated integral with said hollow body (2) along a pre-established breaking line (6) able to allow the separation of said closing cap (5) from said hollow body (2) in an opening configuration wherein on said hollow body (2) is obtained an outflow opening (7) of said fluid product in correspondence to said pre-established breaking line (6), said closing cap (5) comprising at least a substantially sheet-shaped portion (10) for supporting information, data or logos (20);
wherein said vial (1) comprises at least a steady connection brace (13), which has an extremity associated with said hollow body (2) and an opposite extremity associated with said closing cap (5) and which, in said opening configuration, is deformable without breakage and able to avoid the reciprocal moving away between said closing cap (5) and said hollow body (2) beyond a pre-established distance.

2) Vial (1) according to claim 1, wherein said hollow body (2), said closing cap (5) and said steady connection brace (13) are made integral in a single body piece in said initial configuration.

3) Vial (1) according to claim 1, wherein said hollow body (2) has a longitudinal axis (L) in correspondence to which are arranged said pre-established breaking line (6) in said initial configuration and said outflow opening (7) in said opening configuration.

4) Vial (1) according to claim 3, wherein, in the proximity of said closing cap (5), said hollow body (2) ends up into a neck (12) which extends along said longitudinal axis (L) and has said pre-established breaking line (6) in said initial configuration and said outflow opening (7) in said opening configuration.

5) Vial (1) according to claim 1, wherein said hollow body (2) comprises at least a substantially protruding spacing fin (3) which is associated along a first weakened area (8) with the spacing fin (3) of another vial (1) arranged adjacent to form a strip (S) of vials (1).

6) Vial (1) according to claim 1, wherein said closing cap (5) is associated along a second weakened area (9) with the closing cap (5) of another vial (1) arranged adjacent to form a strip (S) of vials (1).

7) Vial (1) according to claim 4, wherein said steady connection brace (13) has an extremity associated with said neck (12) and the opposite extremity associated with said substantially sheet-shaped portion (10).

8) Vial (1) according to claim 5, wherein said steady connection brace (13) has an extremity associated with said spacing fin (3) and the opposite extremity associated with said substantially sheet-shaped portion (10).

9) Vial (1) according to claim 1, wherein said closing cap (5) comprises at least a clogging element (14) which can be inserted in said outflow opening (7) to reclose said vial (1).

10) Vial (1) according to claim 9, wherein, in said initial configuration, said clogging element (14) is associated integral with said hollow body (2) along said pre-established breaking line (6), said clogging element (14) being removable by tearing off from said hollow body (2) to define said outflow opening (7).

11) Vial (1) according to claim 9, wherein:
in said initial configuration said clogging element (14) is associated with said substantially sheet-shaped portion (10) in a different point with respect to said pre-established breaking line (6); and
in said opening configuration said steady connection brace (13) is deformable to allow the alignment of said clogging element (14) with said outflow opening (7).

12) Vial (1) according to claim 9, wherein:
in said initial configuration said clogging element (14) is associated with said substantially sheet-shaped portion (10) on the opposite side with respect to said pre-established breaking line (6); and
in said opening configuration said steady connection brace (13) is deformable to allow the rotation of said substantially sheet-shaped portion (10) by about 180° around a rotation axis (R) and the alignment of said clogging element (14) with said outflow opening (7).

13) Vial (1) according to claim 12, wherein said rotation axis (R) is substantially orthogonal to said longitudinal axis (L).

14) Vial (1) according to claim 13, wherein said steady connection brace (13) comprises:
a first length (15) substantially longitudinal which is associated with said hollow body (2); and
a second length (16) substantially transversal which is connected to said first length (15), is associated with said closing cap (5) and defines said rotation axis (R).

15) Vial (1) according to claim 9, wherein said closing cap (5) comprises at least a cylindrical wall (19) which is associated with said substantially sheet-shaped portion (10) around said clogging element (14).

16) Vial (1) according to claim 15, wherein said cylindrical wall (19) is substantially coaxial to said clogging element (14).

17) Vial (1) according to claim 15, wherein said cylindrical wall (19) can be fitted around said neck (12) when said clogging element (14) is inserted in said outflow opening (7).

18) Vial (1) according to claim 3, wherein said vial (1) comprises two of said steady connection braces (13) arranged on opposite sides with respect to said longitudinal axis (L).
